(19) United States
(12) Patent Application Publication
(10) Pub. No.: US 2007/0289303 A1
(43) Pub. Date: Dec. 20, 2007

(54) HEAT TRANSFER FOR OCEAN THERMAL ENERGY CONVERSION

(76) Inventor: Melvin L. Prueitt, Los Alamos, NM (US)

Correspondence Address: Melvin Prueitt, 161 Cascabel St., Los Alamos, NM, 87544, US

(21) Appl. No.: 11/755,138

(22) Filed: May 30, 2007

Related U.S. Application Data
(60) Provisional application No. 60/804,827, filed on Jun. 15, 2006.

(51) Int. Cl. F03G 7/05

(52) U.S. Cl. 60/641.7

(57) ABSTRACT

For OTEC (Ocean Thermal Energy Conversion), rather than transfer huge quantities of cold water from deep in the ocean to the surface to provide a heat sink for a heat engine or for desalination, this invention provides a method of using small masses of low-boiling-point fluids to absorb heat in a heat exchanger near the ocean surface using the latent heat of evaporation and then depositing the latent heat of condensation in a deep ocean heat exchanger, using the cold seawater as a heat sink. The condensed liquid is pumped back to the ocean surface. The heat engine (turbine) and generator can be at the ocean surface, or it can be in deep ocean. By using a fluid that transfers heat by evaporation and condensation, much larger quantities of heat can be moved per kilogram of fluid than can be transferred by moving the same mass of seawater.

### CROSS-REFERENCE TO RELATED APPLICATION

This claims priority to and the benefit of Provisional U.S. patent application Ser. No. 60/804827, filed Jun. 15, 2006, the entirety of which is hereby incorporated herein by reference.

### BACKGROUND OF THE INVENTION

Using the temperature differential between the surface of the tropical ocean and the water 1,000 meters down is an important way to provide abundant electrical power. The Ocean Thermal Energy Conversion (OTEC) method uses the warm surface water to boil a working liquid to produce a vapor that drives a turbine, and it pumps cold water from the dark depths to the surface to condense the vapor after it leaves the turbine. A 100 MW OTEC plant would require 200 cubic meters of cold water per second flowing up through a 11 meter (36 foot) diameter pipe. Since the cold water is denser than the surrounding water, just lifting the extra weight of the water would require about 3.5 MW of power. The resistance to the flow due to the viscosity of the water would require 20 to 30 additional MW of pumping power.

Another problem with this method of transporting heat is that only a portion of the heat is delivered once the masses of water reach their destination. Even though there is a 23° C. temperature differential, the cold water temperature rises by about only 6° once it reaches the plant heat exchangers. The rest of the “coldness” is thrown away.

U.S. Pat. No. 4,104,883 provides a method of transferring heat for an OTEC plant by using phase change methods. Somewhat related to the present invention is U.S. Pat. No. 4,324,983.

### SUMMARY OF THE INVENTION

Rather than move large quantities of cold water from the depths, this invention provides a method that moves the heat by the most economical method possible while leaving the water where it is. It uses a long “heat pipe” for transporting the energy over the kilometer distance. A heat pipe is a long tube that uses vapor to transfer large amounts of heat. When the vapor gets to the cool end, it condenses and releases its heat. Normally, heat pipes have an interior wick that moves the condensed liquid back to the hot end. Since it would not be practical to have a wick transport the liquid for a kilometer of vertical distance, the heat pipe described herein will pump the liquid to the surface. Since it is different than the standard heat pipe, we may call it a “heat channel.”

The heat channel forms a conduit for conducting a low-boiling-point fluid vapor from the top to the bottom of the system. An evaporation chamber at the top of the heat channel absorbs heat and uses that heat to vaporize the fluid. The vapor then flows down the pipe to the bottom, where it condenses and releases large quantities of heat. The condensed liquid is then pumped back up to the top, where it re-enters the evaporation chamber to repeat the process.

It is therefore an object of the present invention to provide a means of moving large quantities of heat from the top of an OTEC plant to the location of cold water deep in the ocean by using evaporation of a fluid, conducting the fluid from the ocean surface to deep ocean, and condensing the fluid.

It is another object of the present invention to increase the efficiency of an OTEC plant by its method of transferring heat in heat exchangers at constant temperatures.

It is another object of the present invention to eliminate the energy requirements of pumping large quantities of cold seawater to the surface.

It is another object of the present invention to provide a means of utilizing natural deep ocean currents or convection currents to force the cold seawater through the heat exchanger in deep ocean.

Other objects, advantages and novel features, and further scope of applicability of the present invention will be set forth in part in the detailed description to follow, taken in conjunction with the accompanying drawings, and in part will become apparent to those skilled in the art upon examination of the following, or may be learned by practice of the invention. The objects and advantages of the invention may be realized and attained by means of the instrumentalities and combinations particularly pointed out in the appended claims.

### BRIEF DESCRIPTION OF THE DRAWINGS

The accompanying drawings, which are incorporated into and form a part of the specification, illustrate embodiments of the present invention and, together with the description, serve to explain the principles of the invention. The drawings are only for the purpose of illustrating preferred embodiments of the invention and are not to be construed as limiting the invention. In the drawings:

FIG. 1 is a schematic side view drawing of an Ocean Power System plant that uses a long heat channel to conduct a heat transfer vapor from the ocean surface to a boiler that boils a working fluid at deep point in the ocean. The working fluid drives a turbine and is condensed in a cold water condenser.

FIG. 2 is a schematic side view of a simpler method in which the turbine working fluid and the heat transfer fluid are the same.

FIG. 3 is a schematic side view of an embodiment of an Ocean Power System that has the boiler and turbine near the surface of the ocean and has the condenser at deep ocean.

### DETAILED DESCRIPTION OF THE INVENTION

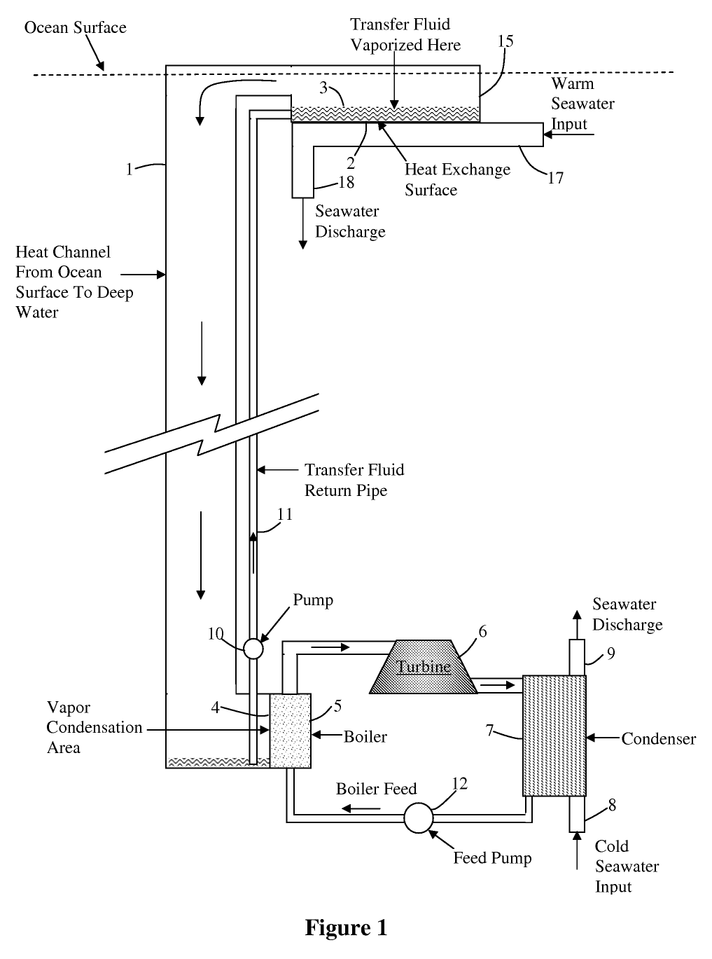

Let us first consider a design in which the turbines, generators, and heat exchangers are at 1,000-meter depth. (Later we will look at the design which has the turbine and generator at the surface). FIG. 1 gives a schematic presentation of the design. At the ocean surface, warm seawater entering pipe 17 is pumped through a heat exchanger or simply moved across a heat exchange surface 2 on the bottom of an evaporation tank 15 that transfers heat into a heat transfer liquid 3 that evaporates and carries the latent heat of evaporation down the heat channel 1 to a depth of 1,000-meters. It should be understood that the heat transfer can be done with a heat exchanger that has many heat transfer surfaces. The drawing of FIG. 1 presents the concept with a single surface for simplicity.

At the bottom, the vapor condenses on a heat exchange surface 4 (or in a heat exchanger) and transfers heat into a working fluid in a boiler 5, and the working fluid drives a turbine 6 to produce electricity.

The exhaust from the turbine is condensed in a heat exchanger 7 by cold seawater, which enters by pipe 8 and is exhausted by pipe 9. Since the cold seawater is nearby, larger quantities can be used so that the temperature rise is smaller, and the condensing temperature of the turbine exhaust can be lower, and the efficiency will be higher. Similarly, at the ocean surface, the warm water is nearby, so that larger quantities can be used to supply the heat. The warm seawater, after delivering its heat to the evaporation tank is exhausted through pipe 18.

The turbine working fluid liquid flows from the heat exchanger 7 via boiler feed pump 12 back to the boiler 5.

The condensed transfer fluid is pumped back by pump 10 via pipe 11 to the evaporation tank 15 at the ocean surface.

We may call this type of power generating plant “Ocean Power System” (OPS).

The heat channel pipe needs to be strong steel to sustain the ocean pressure at depth. However there must be excellent thermal insulation between the ocean and the transfer fluid vapor. The pipe should have a lighter insert pipe that may have an evacuated half-inch gap between it and the outer pipe. The inside of the main pipe and the outside of the insert should be highly reflective to reduce radiative heat loss. The buoyancy of the pipe should be matched by the weight of the pipe so that it would not be necessary to provide strong support for the pipe from above or to anchor it by cables from below. For a pipe with an internal cross sectional area of one square meter, a steel pipe would need to have a thickness of 4.05 cm (1.59 inches) to meet this criterion. That would probably provide sufficient strength so sustain the water pressure. If necessary, the pipe can be thin near the top and be thicker near the bottom.

The transfer fluid can be a liquid that has a fairly low boiling point. Calculations were made with a computer program called “Otec.exe,” which numerically follows the vapor from the top to the bottom of the long pipe. Some results are given in Table I. Since the viscosities and densities of vapors are much less than liquids, the velocities can be much higher than that of the cold water that would be pumped in ordinary OTEC plants. Since latent heats of evaporation and condensation are much greater than the heat capacity of water for the same mass, much less mass needs to be transferred.

TABLE I
“Top Pressure” and “Top Density” mean the pressure and density of the vapor at
the top of the heat channel as the vapor begins to flow downward. “Energy
Delivered” means the amount of energy deposited in the boiler at the bottom of the
pipe. “Plant Power” means the theoretical amount of power put out by the turbine.
“Pump Power” means the amount of power required to pump the condensed
transfer fluid back up to top. “Net Power” is the result of subtracting the Pump
Power from the Plant Power. “Net Efficiency” compares the Net Power to the heat
“Energy Delivered” to the bottom of the heat channel.

| | Top | Top | Latent | Energy | Pressure | Temperature | Plant | Pump | Net | Net |
|---|---|---|---|---|---|---|---|---|---|---|
| Transfer | Pressure | Density | Heat | Delivered | At Bottom | At Bottom | Power | Power | Power | Efficiency |
| Fluid | (bars) | (kg/m³) | (kj/kg) | (MW) | (bars) | (degrees C) | (MW) | (MW) | (MW) | (%) |
| Ammonia | 10.61 | 8.264 | 1158 | 717 | 11.43 | 32.3 | 59.4 | 4.66 | 54.7 | 7.6 |
| Water | 0.0353 | 0.0256 | 2438 | 4.674 | 0.0378 | 31.9 | 0.382 | 0.018 | 0.367 | 7.8 |
| Acetone | 0.318 | 0.707 | 533 | 28.26 | 0.3899 | 38.1 | 2.82 | 0.520 | 2.30 | 8.1 |
| Propane | 9.997 | 21.69 | 333 | 541 | 12.322 | 37.6 | 53.3 | 11.64 | 41.7 | 7.7 |
| Methanol | 0.20 | 0.263 | 1161 | 22.9 | 0.2272 | 33.5 | 1.97 | 0.194 | 1.78 | 7.8 |
| Decane | 0.0020 | 0.0113 | 360 | 0.305 | 0.00337 | 55.1 | 0.045 | 0.008 | 0.037 | 12.0 |
| R134A | 8.0 | 38.99 | 272 | 795 | 12.67 | 50.9 | 107.7 | 26.3 | 81.4 | 10.2 |
| Propylene | 12.12 | 25.64 | 331 | 637 | 14.86 | 37.4 | 62.4 | 12.9 | 49.5 | 7.8 |

For the calculations of Table I, I used 27° C. (300 K, 80.6° F.) for the starting temperature at the top, since it was easy to look up in a thermodynamics table. I assumed the vertical pipe to have an inside diameter of 1.128 meters (cross sectional area of 1 m²). I used a vapor velocity of 75 meters per second for all items, although this may be too high for some of the high-density vapors and too small for the low-density vapors. If, after closer examination, it is determined that the velocity is too high, we can double the inside diameter of the pipe, and that will reduce the velocity by a factor of 4 and will reduce the drag loss by a factor of 16, while still delivering the same amount of fluid. If it is difficult to find strong pipes of the larger diameter, bundles of smaller pipes may be used, especially at deep locations.

For this table, fluids were chosen to show a variety of different characteristics. Note that the temperature at the bottom of the heat channel pipe is hotter than the initial temperature (27° C.). That is because as the vapor flows downward, the weight of the vapor above it compresses it, increasing the temperature and the pressure.

Notice that for some of the fluids, there is considerable pressure at the bottom of the heat channel. That pressure assists in pumping the transfer liquid upward. This effect was included in the pump power calculations. In other liquids, the pressure provides insignificant lift.

The increase in temperature of the transfer vapor at the bottom is a significant aspect of the Ocean Power System. Whenever there is a heat engine that has a small temperature differential between the input and output temperatures, any small increase in that differential can dramatically improve the efficiency.

We can compare this with the OTEC design shown on slide 14 of the Sea Solar Power OTEC Presentation.ppt. There it shows 80° F. (almost 27° C.) input, but the boiler is operating at 73° F., and that is the temperature of the steam (or other working fluid) as it goes to the turbine. Even though the seawater is 40° F., the condenser is operating at 50° F. The temperature differential is 23° F. The theoretical efficiency is 4.3%. Of course, both the standard OTEC plant and the OPS will operate below the Carnot efficiencies, but the theoretical efficiencies provide a guide to which real system will perform more efficiently.

We should examine the reasons for the differences in efficiencies. At the top in the OPS plant, the heat transfer fluid evaporates at constant temperature. Since this heat is supplied from nearby ocean water, large quantities of water can be used so that there is a small drop in temperature of the water. The heat transfer vapor increases in temperature as it flows downward and condenses at constant temperature as it boils the working fluid in the boiler at constant temperature. That is, the heat transfer into the boiling working fluid occurs at the high temperature point of the cycle, and this temperature is higher than the temperature of the ocean at the surface. If, instead of using the heat channel, warm water from the ocean surface were pumped down to the boiler, the temperature of the water would drop down several degrees during heat exchange, and the temperature of the boiler working fluid would be that of the lowest temperature of the seawater from the surface. This means that the efficiency will be less. The other problem is that only a small fraction of the heat energy transported in the water is actually used. With the heat transfer fluid in the heat channel, nearly all the transported energy is used.

After the working fluid vapor leaves the turbine, it is condensed by cold seawater. If that water had to be pumped up one kilometer to a turbine at the ocean surface, it would be a precious commodity, and there would be a fairly large temperature change, meaning that the condensation temperature would be higher, again meaning that the efficiency would be lowered. If the turbine is at the bottom of the heat channel pipe, larger quantities of cold water could be used, the condensation temperature would be lower, and the efficiency would be higher.

Consider an example. If the ocean surface temperature is 27° C., and the warm water cools by 2° as it provides heat to evaporate the heat transfer vapor, the vapor would start out at 25° C. By the time the vapor reached the bottom, the temperature might be 35° C. If the seawater temperature there is 4° and it warms up to 6° as it condenses the working fluid from the turbine, the condensation temperature would be 6°. The Carnot efficiency would be 9.4% (compared to 4.3% for present designs).

One thing that should be considered when the transfer fluid is compressed and increases in temperature is that it departs slightly from saturation properties. That is, since it is compressed adiabatically, its temperature is increased and it is in a superheated state and will not condense unless it contacts a surface that has a temperature below its new saturation temperature. In a specially designed heat exchanger, the condensation of the fluid releases the heat to boil the working fluid while the initial cool-down energy could be used to superheat the working fluid.

### A Simpler Design

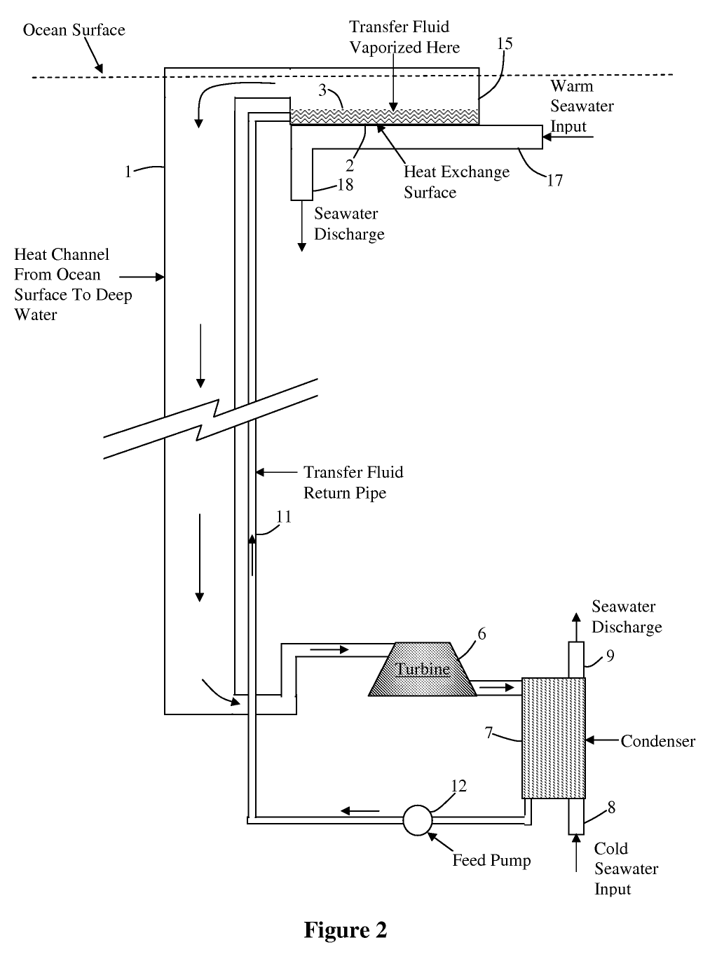

Rather than having different fluids for the turbine working fluid and the heat transfer fluid, we can use the same fluid. This is illustrated in FIG. 2. As in the description above, the heat transfer fluid is boiled in evaporation tank 15 (or in a multi-surface heat exchanger) and flows down heat channel 1. At the bottom, it flows into the turbine 6 to produce power. The exhaust from the turbine flows into condenser 7 and is condensed to a liquid. Feed Pump 12 pumps the liquid back to the evaporation tank 15 (or a multi-surface heat exchanger) at the ocean surface to repeat the cycle.

The Carnot efficiency of this design is the same as the design of FIG. 1, but it would probably be more efficient, since it eliminates a couple of heat exchangers. There is always some inefficiency in heat exchangers. The only reason for using the more complicated designs is that there may be some reason for using a different fluid for the turbine working fluid and for the heat transfer fluid.

### The “Right-Side-Up” Ocean Power System

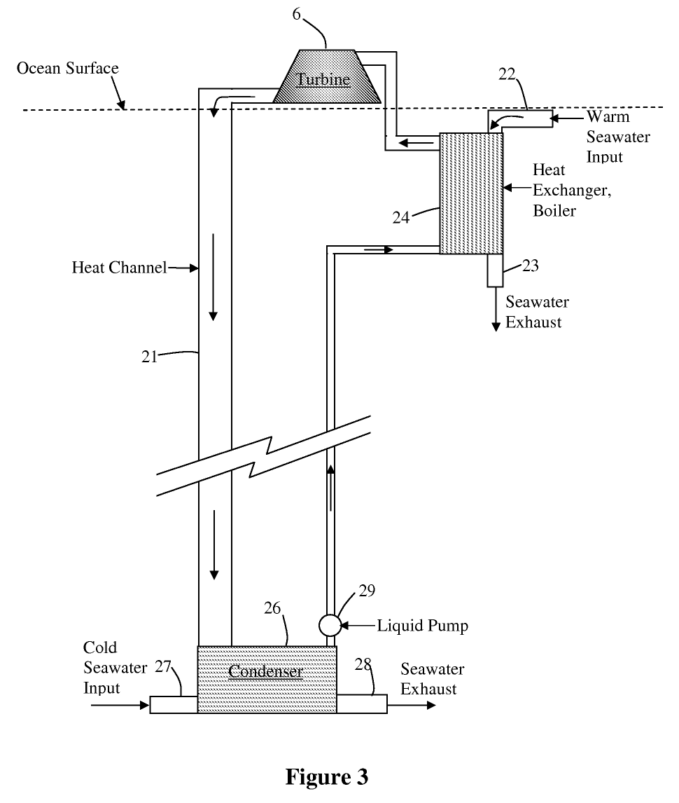

The description above was used to explain the principle, and it has some thermodynamic advantages. Most people involved with OTEC would prefer to have the turbines and generators at the surface of the ocean. FIG. 3 schematically shows how it works. Warm seawater enters heat exchanger boiler 24 via pipe 22 and supplies heat to boil the working fluid, which then flows to the turbine 6. The warm ocean water exits via pipe 23. Exhaust vapor from the turbine flows down the heat channel 21 to a condenser 26 in deep ocean. There it is condensed by cold ocean water entering by pipe 27. The condensed liquid is then pumped back up to the heat exchanger 24 at the ocean surface by pump 29. The liquid is boiled in the heat exchanger boiler 24 and returned to the turbine again. The cold exhaust seawater is exhausted through pipe 28.

If desalination is desired, a separate evaporator at the ocean surface could evaporate seawater, and it could be condensed in a heat exchanger that evaporates some heat transfer fluid, which would then flow down the heat channel to be condensed by cold seawater.

### Advantages of the OPS Method

1. Higher efficiency.

2. Warm and cold water do not have to be moved very far.

3. Cold water does not have to be “dumped” near the ocean surface, which means less ecological effects.

4. Pipes are much smaller diameter.

5. Rather than having to pump 200 tons per second of cold water from one-kilometer depths, this method would require pumping about one ton of transfer fluid per second to produce 100 MW of power.

6. Rather than requiring 20% to 30% of the plant output to pump the water, it might require less than 10% to pump the transfer fluid.

What is claimed is:

1. A heat transfer system for transferring heat from near the ocean surface to a location far below the ocean surface, comprising:
a heat exchanger evaporator near the ocean surface, which uses warm ocean water to provide heat for evaporating a low-boiling-point liquid to produce a vapor; and
a conduit for conducting the vapor to a location far below the ocean surface; and
a heat exchanger condenser at the location far below the ocean surface for the purpose of condensing the vapor back to a liquid; and
a pump and pipe for moving the condensed liquid back to the heat exchanger evaporator near the surface of the ocean;
wherein heat absorbed from warm ocean water by the heat exchanger evaporator causes the evaporation of the low boiling point liquid for the purpose of absorbing the latent heat of evaporation as it produces a vapor, and wherein the vapor is transported to the heat exchanger condenser where it condenses to a liquid as it releases the latent heat of condensation, and wherein the liquid is pumped by the pump and through the pipe back to the heat exchanger evaporator.

2. A heat transfer system according to claim 1, wherein the vapor that flows from the heat exchanger evaporator to the location far below the ocean surface transfers the heat to the heat exchanger condenser and wherein the heat thus delivered to the heat exchanger condenser is used to boil a working fluid that is used to drive a turbine or other heat engine and wherein the exhaust from the turbine or other heat engine is condensed in a heat exchanger that is cooled by cold deep ocean seawater, and wherein the condensed working fluid is pumped by a feed pump back into the heat exchanger condenser to be boiled again.

3. A heat transfer system according to claim 1, wherein the vapor that flows from the heat exchanger evaporator to the location far below the ocean surface flows through a turbine or other heat engine on the way to the heat exchanger condenser, and wherein the vapor is condensed to a liquid in the heat exchanger condenser by the cold ocean water, and the liquid pumped back to the heat exchanger evaporator near the ocean surface.

4. A heat transfer system for transferring heat from the ocean surface to a location far below the ocean surface, comprising:
a conduit for conducting exhaust vapor consisting of a low-boiling-point fluid from a turbine or other heat engine or from a desalination unit near the surface of the ocean to a location far below the ocean surface; and
a heat exchanger condenser far below the surface of the ocean for the purpose of condensing the vapor to a liquid; and
a heat exchanger boiler near the surface of the ocean for the purpose of transferring heat from the warm surface seawater to heat and evaporate the liquid; and
a pipe to conduct the heated and evaporated vapor from the heat exchanger boiler to the turbine or other heat engine or to the desalination plant; and
a pump and a second pipe for moving the condensed liquid from the heat exchanger condenser through a pipe to the heat exchanger boiler near the surface of the ocean for the purpose of heating and re-evaporating the liquid;
wherein warm ocean surface water is used to heat and evaporate the low-boiling-point fluid to produce a vapor in the heat exchanger boiler, which vapor is conducted to the turbine or other heat engine or to the desalination of seawater, and wherein the exhaust vapor from the turbine or other heat exchanger or desalination plant is conducted by the conduit to a location far below the ocean surface to be condensed in the heat exchanger condenser, which deposits the heat of condensation of the vapor into the cold seawater and wherein the condensed liquid is pumped by the pump and the second pipe back to the heat exchanger boiler at the surface of the ocean.
